(19) United States
(12) Patent Application Publication
(10) Pub. No.: US 2023/0178866 A1
(43) Pub. Date: Jun. 8, 2023

(54) APPARATUS, SYSTEM, AND METHOD FOR SHIFTING THE PHASE OF AN ELECTRICAL SIGNAL

(71) Applicant: Amphenol Antenna Solutions, Inc., Rockford, IL (US)

(72) Inventors: Kostyantyn Semonov, Denver, NC (US); James Crawford Carson, Newton, NC (US); Michael Piessens, Hickory, NC (US); Charles Gaither, Conover, NC (US)

(21) Appl. No.: 17/544,324

(22) Filed: Dec. 7, 2021

(51) Int. Cl. H01Q 3/12; H04B 1/40; H01Q 1/48

(52) U.S. Cl. CPC H01Q 3/12; H01Q 1/48; H04B 1/40; H01Q 1/246

(57) ABSTRACT

A device for shifting the phase of an electrical signal includes a first microstrip, a second microstrip, and a ground plate. The first microstrip includes an input terminal and the second microstrip includes an output terminal. The second microstrip is spaced apart from the first microstrip such that a microstrip-to-slot transition region is defined between the first microstrip and the second microstrip. The ground plate includes a ground-plate slot that spans the microstrip-to-slot transition region. The ground plate is coupled with the first microstrip and the second microstrip such that at least one of the first microstrip and the second microstrip are movable relative to each other and to the ground plate to adjust a width of the microstrip-to-slot transition region.

### FIELD

This disclosure relates generally to modulation of an electrical signal, and more particularly to shifting the phase of an electrical signal.

### BACKGROUND

Changing the phase of an electrical signal can be helpful in a variety of applications. For example, in some communication systems, the ability to change the phase of an electrical output signal relative to an electrical input signal enables modification of the angle of an electromagnetic beam emitted from an antenna, such as a small cell antenna.

Conventional devices and methods for changing the phase of an electrical signal may utilize mechanical means to alter the transmission length of an electrical signal. Such mechanical phase shifting devices are typically large, complex, slow, and inefficient.

### SUMMARY

The subject matter of the present application has been developed in response to the present state of the art, and in particular, in response to the shortcomings of passive intermodulation in phase shifting devices, such as those that facilitate variable electric tilt in small cell antennas, that have not yet been fully solved by currently available techniques. Accordingly, the subject matter of the present application has been developed to provide a phase shifting device that overcome at least some of the above-discussed shortcomings of prior art techniques. More specifically, in some examples disclosed herein is a device for shifting the phase of an electrical signal in a simple, fast, and efficient manner.

The following is a non-exhaustive list of examples, which may or may not be claimed, of the subject matter, disclosed herein.

In one example, a device for shifting the phase of an electrical signal comprises a first microstrip, a second microstrip, and a ground plate. The first microstrip comprises an input terminal and the second microstrip comprises an output terminal. The second microstrip is spaced apart from the first microstrip such that a microstrip-to-slot transition region is defined between the first microstrip and the second microstrip. The ground plate comprises a ground-plate slot that spans the microstrip-to-slot transition region. The ground plate is coupled with the first microstrip and the second microstrip such that at least one of the first microstrip and the second microstrip are movable relative to each other and to the ground plate to adjust a width of the microstrip-to-slot transition region. The preceding subject matter of this paragraph characterizes example 1 of the present disclosure.

The device further comprises a transition slot that extends from the first microstrip to the second microstrip and has a dumbbell shape. The transition slot comprises a first-microstrip segment formed in the first microstrip, a second-microstrip segment formed in the second microstrip, and a third segment, contiguous with the first segment and the second segment. The third segment comprises the ground-plate slot. Adjustment of the width of the microstrip-to-slot transition region corresponds with an adjustment to a length of the transition slot. The preceding subject matter of this paragraph characterizes example 2 of the present disclosure, wherein example 2 also includes the subject matter according to example 1.

The device further comprises a transition slot that extends from the first microstrip to the second microstrip and has a dumbbell shape. The transition slot comprises a first transition-slot terminus and a first transition-slot intermediate portion formed in the first microstrip. The transition slot further comprises a second transition-slot terminus and a second transition-slot intermediate portion formed in the second microstrip and a transition-slot middle portion, between the first transition-slot intermediate portion and the second transition-slot intermediate portion. The transition-slot middle portion lengthens and shortens as the width of the microstrip-to-slot transition region increases and decreases, respectively. The preceding subject matter of this paragraph characterizes example 3 of the present disclosure, wherein example 3 also includes the subject matter according to any one of examples 1-2 above.

The input terminal is offset from the output terminal in a direction that is perpendicular to the width of the microstrip-to-slot transition region. The preceding subject matter of this paragraph characterizes example 4 of the present disclosure, wherein example 4 also includes the subject matter according to any one of examples 1-3 above.

The first microstrip comprises a first-microstrip dielectric layer and the second microstrip comprises a second-microstrip dielectric layer. The input terminal of the first microstrip is applied onto the first-microstrip dielectric layer, such that the first-microstrip dielectric layer is between the input terminal of the first microstrip and the ground plate. The output terminal of the second microstrip is applied onto the second-microstrip dielectric layer, such that the second-microstrip dielectric layer is between the output terminal of the second microstrip and the ground plate. The preceding subject matter of this paragraph characterizes example 5 of the present disclosure, wherein example 5 also includes the subject matter according to any one of examples 1-4 above.

A gap is defined between the ground plate and the first microstrip and between the ground plate and the second microstrip. The gap is filled with a dielectric material consisting of at least one of air or a dielectric film. The preceding subject matter of this paragraph characterizes example 6 of the present disclosure, wherein example 6 also includes the subject matter according to any one of examples 1-5 above.

The ground-plate slot has a fixed slot width. The preceding subject matter of this paragraph characterizes example 7 of the present disclosure, wherein example 7 also includes the subject matter according to any one of examples 1-6 above.

The first microstrip further comprises an input trace electrically coupled with the input terminal. The second microstrip further comprises an output trace electrically coupled with the output terminal. Each one of the input terminal and the output terminal has a circular shape. The preceding subject matter of this paragraph characterizes example 8 of the present disclosure, wherein example 8 also includes the subject matter according to any one of examples 1-7 above.

The first microstrip further comprises an input trace electrically coupled with the input terminal. The second microstrip further comprises an output trace electrically coupled with the output terminal. Each one of the input terminal and the output terminal has a non-circular shape. The preceding subject matter of this paragraph characterizes example 9 of the present disclosure, wherein example 9 also includes the subject matter according to any one of examples 1-7 above.

The input terminal and the output terminal have the same shape. The preceding subject matter of this paragraph characterizes example 10 of the present disclosure, wherein example 10 also includes the subject matter according to any one of examples 1-9 above.

The width of the microstrip-to-slot transition region is adjustable between a minimum width and a maximum width, and wherein the minimum width corresponds with a maximum phase shift of the device and the minimum width corresponds with a minimum phase shift of the device. The preceding subject matter of this paragraph characterizes example 11 of the present disclosure, wherein example 11 also includes the subject matter according to any one of examples 1-10 above.

The first microstrip comprises a first-microstrip dielectric layer interposed between the ground plate and the input terminal. The first-microstrip dielectric layer is between the first-microstrip conductive layer and the input terminal. The second microstrip comprises a second-microstrip dielectric layer interposed between the ground plate and the output terminal. The second-microstrip dielectric layer is between the second-microstrip conductive layer and the output terminal. The preceding subject matter of this paragraph characterizes example 12 of the present disclosure, wherein example 12 also includes the subject matter according to any one of examples 1-11 above.

The ground plate is made from aluminum and the first-microstrip conductive layer and the second-microstrip conductive layer are made from copper. The preceding subject matter of this paragraph characterizes example 13 of the present disclosure, wherein example 13 also includes the subject matter according to example 12 above.

A system comprises an input source that generates an electrical input signal. The system also comprises a first microstrip that comprises an input terminal and a second microstrip that comprises an output terminal. The second microstrip is spaced apart from the first microstrip such that a microstrip-to-slot transition region is defined between the first microstrip and the second microstrip. A ground plate comprises a ground-plate slot that spans the microstrip-to-slot transition region. The ground plate is coupled with the first microstrip and the second microstrip such that at least one of the first microstrip and the second microstrip are translationally movable relative to each other and to the ground plate to adjust a width of the microstrip-to-slot transition region such that a phase shift of an electrical output signal is different than the electrical input signal. The system further comprises a transmitter, which receives the electrical output signal and transmits an electromagnetic radiation wave corresponding with the electrical output signal, and a receiver, which receives the electromagnetic radiation wave. The preceding subject matter of this paragraph characterizes example 14 of the present disclosure.

The electrical input signal has a frequency in a group consisting of about 600 MHz, 700 MHz, 1.9 GHz, 2.5 GHz, and 5.2 GHz and the phase shift of the electrical output signal results in the electrical output signal that has a frequency in the group consisting of about 600 MHz, 700 MHz, 1.9 GHz, 2.5 GHz, and 5.2 GHz. The preceding subject matter of this paragraph characterizes example 15 of the present disclosure, wherein example 15 also includes the subject matter according to example 14 above.

The system also comprises a translational actuator that is actuatable to translationally move at least one of the first microstrip and the second microstrip over the ground plate. The preceding subject matter of this paragraph characterizes example 16 of the present disclosure, wherein example 16 also includes the subject matter according to any one of the examples 14-15 above.

The width of the microstrip-to-slot transition is continuously and synchronously adjustable. The preceding subject matter of this paragraph characterizes example 17 of the present disclosure, wherein example 17 also includes the subject matter according to any one of the examples 14-16 above.

A method of shifting the phase of an electrical signal comprises steps of supplying an electrical input signal to an input terminal on a first microstrip and receiving an electrical output signal from an output terminal on second microstrip. A phase of the electrical output signal differs from a phase of the electrical input signal by a first phase shift. The method further comprises moving the first microstrip relative to the second microstrip, while keeping fixed the phase of the electrical input signal, such that the phase of the electrical output signal differs from the phase of the electrical input signal by a second phase shift that is different than the first phase shift. The preceding subject matter of this paragraph characterizes example 18 of the present disclosure.

The step of moving the first microstrip relative to the second microstrip further comprises widening or narrowing a width of a microstrip-to-slot transition region defined between the first microstrip and the second microstrip. The preceding subject matter of this paragraph characterizes example 19 of the present disclosure, wherein example 19 also includes the subject matter according to example 18 above.

Moving the first microstrip relative to the second microstrip comprises translationally moving the first microstrip in a first linear direction, away from or towards the second microstrip, and translationally moving the second microstrip in a second linear direction, away from or towards the first microstrip. The preceding subject matter of this paragraph characterizes example 20 of the present disclosure, wherein example 20 also includes the subject matter according to any one of examples 18-19 above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic, perspective view of a system having a device for shifting the phase of an electrical signal, according to one or more examples of the present disclosure;

FIG. 2A is a schematic, top plan view of the device of FIG. 1, shown in a first configuration, according to one or more examples of the present disclosure;

FIG. 2B is a schematic, top plan view of the device of FIG. 1, shown in a second configuration, according to one or more examples of the present disclosure;

FIG. 3A is a schematic, bottom plan view of the device of FIG. 1, shown in the first configuration, according to one or more examples of the present disclosure;

FIG. 3B is a schematic, bottom plan view of the device of FIG. 1, shown in the second configuration, according to one or more examples of the present disclosure;

FIG. 3C is a schematic, perspective view of a segment of a transition slot formed in a microstrip of the device of FIG. 1, according to one or more examples of the present disclosure;

FIG. 4A is a schematic, perspective view of the device of FIG. 1, shown in the first configuration, according to one or more examples of the present disclosure;

FIG. 4B is a schematic, perspective view of the device of FIG. 1, shown in the second configuration, according to one or more examples of the present disclosure;

FIG. 5 is a schematic, bottom plan view of the device of FIG. 1, according to one or more examples of the present disclosure;

FIG. 6 is a schematic, perspective view of a device for shifting the phase of an electrical signal, according to one or more examples of the present disclosure;

FIG. 7A is a schematic, side elevation view of the device of FIG. 1, according to one or more examples of the present disclosure;

FIG. 7B is a schematic, sectional and side elevation view of the device of FIG. 1, according to one or more examples of the present disclosure;

FIG. 8 is a schematic, top plan view of a device for shifting the phase of an electrical signal, according to one or more examples of the present disclosure;

FIGS. 9A-9C are respective voltage-time charts for electrical signals, according to one or more examples of the present disclosure; and

FIG. 10 is a flow chart of a method of shifting the phase of an electrical signal, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

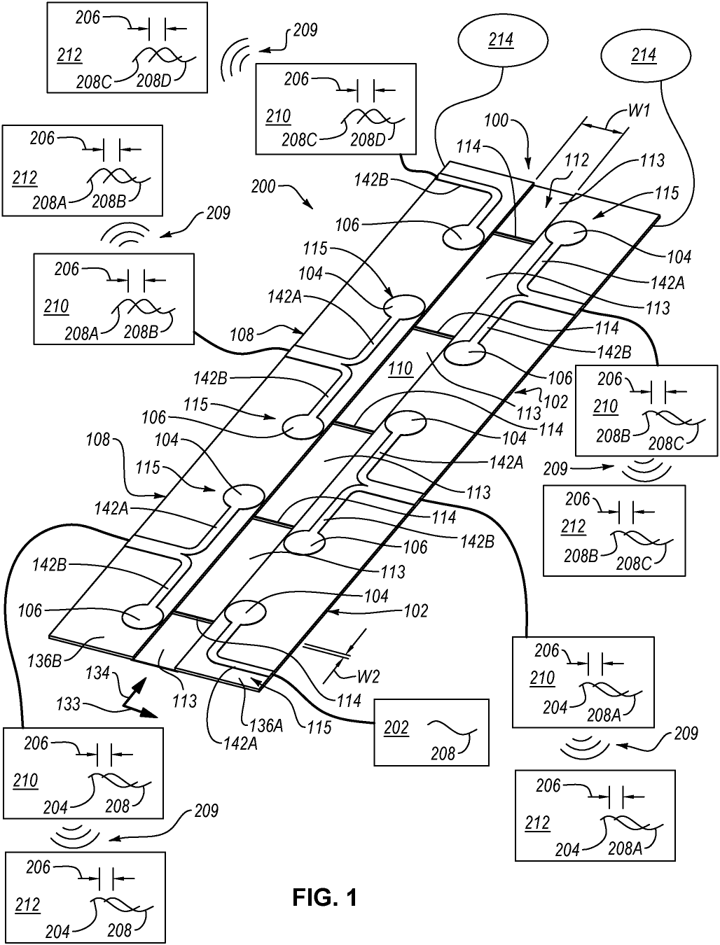

Referring to FIG. 1, one example of a system 200 includes a device 100 for shifting the phase of an electrical signal. The system 200 further includes an input source 202 that is selectively operable to generate an electrical input signal 204. In certain examples, the electrical input signal 204 has an alternating current. The system 200 also includes a plurality of transmitters 210 that are selectively operable to receive a corresponding one of a plurality of electrical output signals 208 from the device 100. In certain examples, each one of the transmitters 210 is also configured to transmit the electrical output signal 208, received from the device 100, to a corresponding one of a plurality of receivers 212 of the system 200 as an electromagnetic radiation wave 209 (e.g., radio wave). Accordingly, in such examples, each one of the transmitters 210 can include a first antenna and each one of the receivers 212 can include a second antenna. The system 200 can be configured to change the angle of the electromagnetic radiation wave 209 transmitted from the transmitters 210 in response to changes in the phase of the electrical input signal 204 by the device 100. The system 200 can include a controller, or control module, that is configured to control the device 100, as disclosed below, to achieve desired changes in the phase of the electrical input signal 204 and to control the transmitters 210 to generate electromagnetic radiation waves 209 corresponding with the desired changes in the phase of the electrical input signal 204.

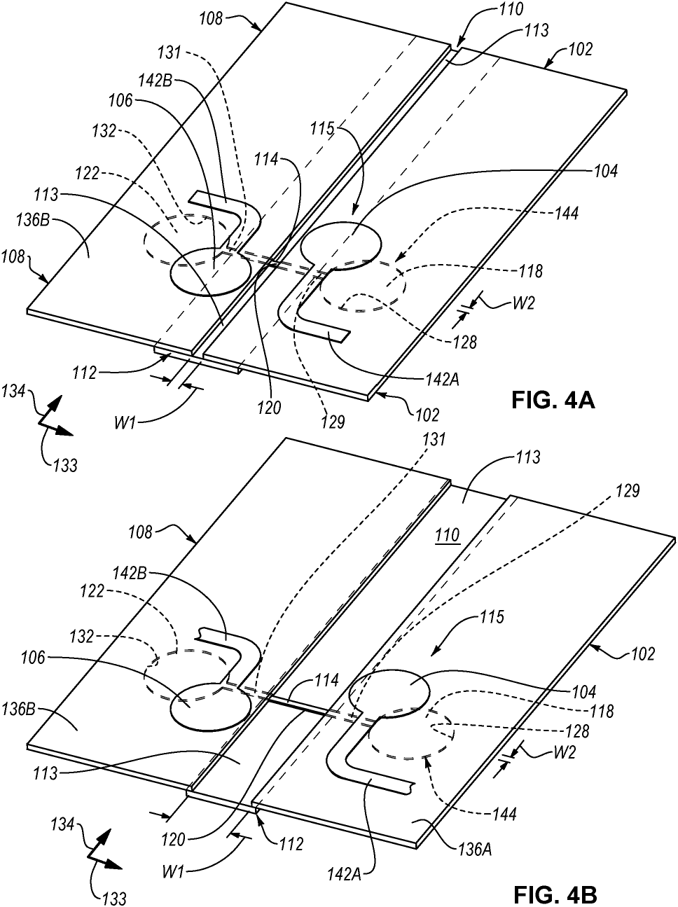

The device 100, or phase-shifting device, includes a first microstrip 102 and a second microstrip 108. The first microstrip 102 and the second microstrip 108 are spaced apart from each other such that a microstrip-to-slot transition region 110 is defined between the first microstrip 102 and the second microstrip 108. In some examples, the microstrip-to-slot transition region 110 is defined as the gap between the first microstrip 102 and the second microstrip 108. The first microstrip 102 and the second microstrip 108 are movable (e.g., linearly movable) toward and away from each other in directions parallel to a lateral direction 133 and perpendicular to a longitudinal direction 134. Movement of the first microstrip 102 and the second microstrip 108 relative to each other adjust a width W1 of the microstrip-to-slot transition region 110, which extends parallel to the lateral direction 133. More specifically, movement of the first microstrip 102 and the second microstrip 108 toward each other decreases the width W1 of the microstrip-to-slot transition region 110. In contrast, movement of the first microstrip 102 and the second microstrip 108 away from each other increases the width W1 of the microstrip-to-slot transition region 110. For example, the width W1 of the microstrip-to-slot transition region 110 in FIG. 4A is less than the width W1 of the microstrip-to-slot transition region 110 in FIG. 4B because the first microstrip 102 and the second microstrip 108 are closer to each other than in FIG. 4B.

The first microstrip 102 also includes at least one input terminal 104 and the second microstrip 108 also includes at least one output terminal 106, corresponding with the at least one input terminal 104. Additionally, in the example shown in FIG. 1, where the device 100 is configured to provide a chain of phase shifters, the first microstrip 102 also includes at least one output terminal 106 and at least one input terminal 104. In the example of FIG. 1, the first microstrip 102 includes a plurality of input terminals 104 and output terminals 106 and the second microstrip 108 includes a plurality of input terminals 104 and output terminals 106.

One input terminal 104 of the device 100 and one output terminal 106 of the device 100 form part of a phase-shifting circuit 115 of the device 100. The input terminal 104 and the output terminal 106 of each phase-shifting circuit 115 is offset from each other in a direction that parallel to the longitudinal direction 134 or perpendicular to the width W1 of the microstrip-to-slot transition region 110. Accordingly, in the example of FIG. 1, the device 100 includes multiple phase-shifting circuits 115 each formed from a corresponding one of multiple input terminals 104 and a corresponding one of multiple output terminals 106. The device 100 further includes at least one input trace 142A, electrically coupled with a corresponding input terminal 104, and at least one output trace 142B, electrically coupled with a corresponding output terminal 106. One input trace 142A and one output trace 142B form part of one phase-shifting circuit 115 of the device 100. The input trace 142A and the output trace 142B of a given phase-shifting circuit 115 provide an electrical connection to the input terminal 104 and from the output terminal 106, respectively, of the given phase-shifting circuit 115.

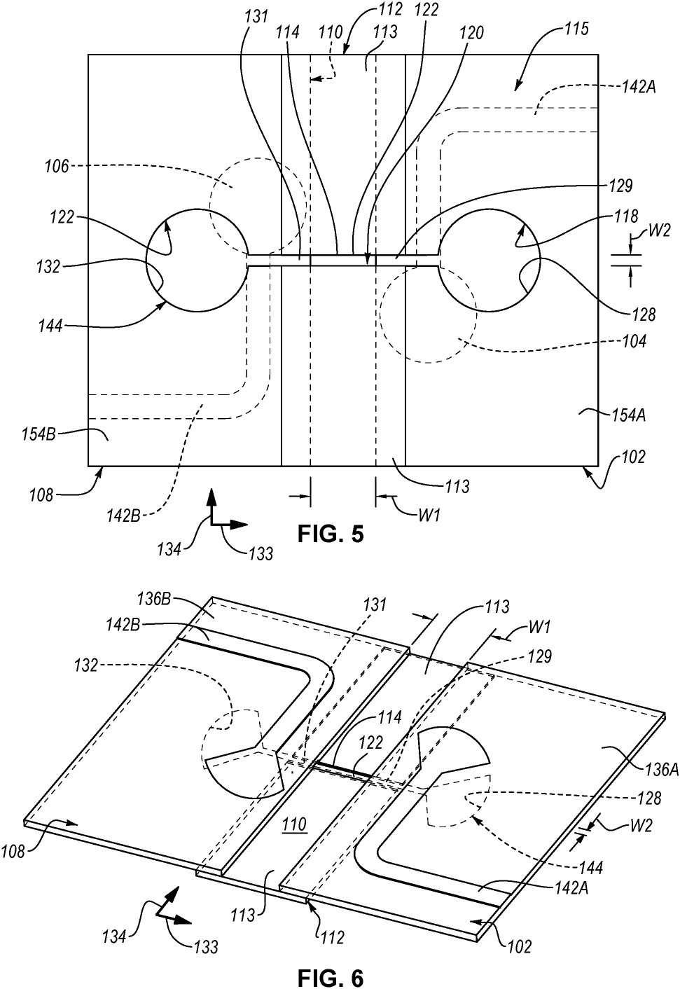

In some examples, the input trace 142A and the output trace 142B are narrower than the input terminal 104 and the output terminal 106, respectively. In some examples, the input terminal 104 and the output terminal 106 have the same shape, which can be a circular shape (see, e.g., FIGS. 1-5 and 8) or can be a non-circular shape (see, e.g., FIG. 6). A non-circular shape can be any of various shapes that does not include a full circle. Accordingly, the quarter-circle shape of the input terminal 104 and the output terminal 106 of FIG. 6 is a non-circular shape. Other non-circular shapes, such as semicircular, arc, triangular, rectangular, oval, polyhedron, and the like can be used.

The first microstrip 102 and the second microstrip 108 also include a dielectric layer and a conductive layer. More specifically, the first microstrip 102 includes a first-microstrip dielectric layer 136A and the second microstrip 108 includes a second-microstrip layer dielectric 136B. Each one of the first-microstrip dielectric layer 136A and the second-microstrip dielectric layer 136B is made of a dielectric material, such as polymers, glass, silicon dioxide, calcium copper titanate, barium titanate, polyvinylidene fluoride, polycarbons, porcelain, quartz, polyvinyl chloride, zirconium dioxide, zirconium silicate, bakelite, and/or teflon (PTFE). The input terminal 104 and the input trace 142A are applied onto, formed on, or otherwise coupled to a surface of the first-microstrip dielectric layer 136A. Similarly, the output terminal 106 and the output trace 142B are applied onto, formed on, or otherwise coupled to a surface of the second-microstrip dielectric layer 136B.

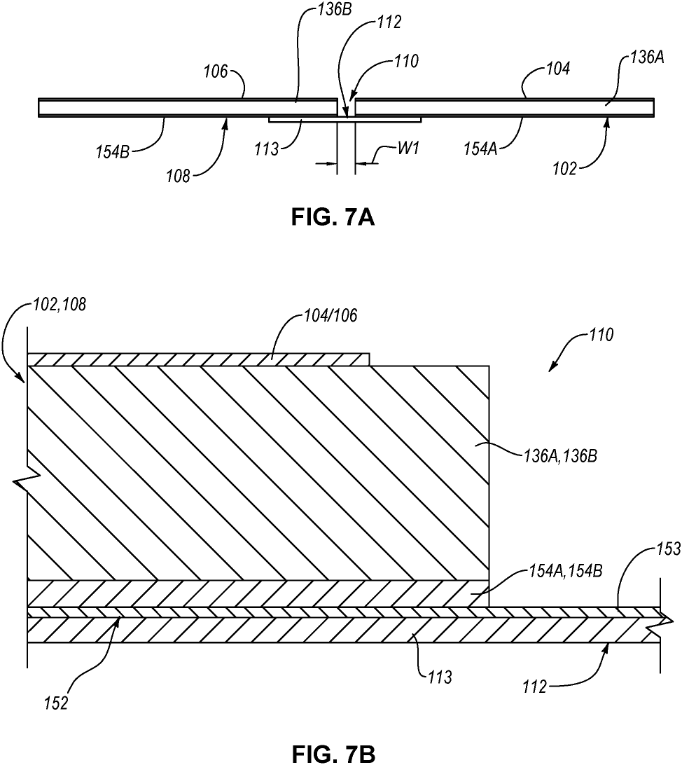

Referring to FIGS. 7A and 7B, the first microstrip 102 includes a first-microstrip conductive layer 154A coupled to a surface of the first-microstrip dielectric layer 136A, opposite the surface to which the input terminal 104 and the input trace 142A are coupled. Accordingly, the first-microstrip dielectric layer 136A is interposed between the first-microstrip conductive layer 154A and the input terminal 104 and the input trace 142A. The second microstrip 108 includes a second-microstrip conductive layer 154B coupled to a surface of the second-microstrip dielectric layer 136B, opposite the surface to which the output terminal 106 and the output trace 142B are coupled. Accordingly, the second-microstrip dielectric layer 136B is interposed between the second-microstrip conductive layer 154B and the output terminal 106 and the output trace 142B. The first-microstrip conductive layer 154A and the second-microstrip conductive layer 154B are made of an electrically conductive material, such as copper, in some examples. The dielectric material of the first-microstrip dielectric layer 136A and the second-microstrip dielectric layer 136B can be a high-k or low-k dielectric material that electrically insulates the input terminal 104 and the input trace 142A from the first-microstrip conductive layer 154A and electrically insulates the output terminal 106 and the output trace 142B from the second-microstrip conductive layer 154B, respectively. In FIG. 7B, dual reference numbers are used to reference a single feature because the feature referenced can be applicable to either one of the reference numbers.

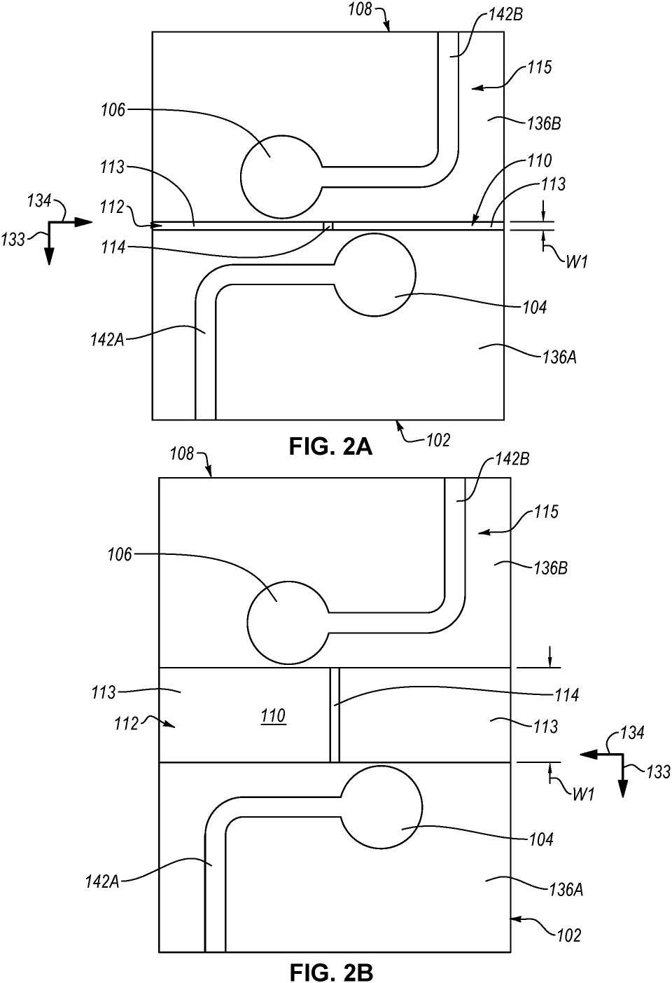

Additionally, the device 100 includes a ground plate 112 that spans the microstrip-to-slot transition region 110 in a direction parallel to the lateral direction 133. Moreover, the ground plate 112 also spans along at least a substantially portion (e.g., an entirety) of the length of both the first microstrip 102 and the second microstrip 108, in a direction parallel to the longitudinal direction 134. The ground plate 112 includes at least two ground-plate segments 113, which are spaced apart from each other such that a ground-plate slot 114 is defined between each one of the ground-plate segments 113 and an adjacent one of the ground-plate segments 113. The ground plate 112 of the device 100 of FIG. 1 includes six ground-plate segments 113 and five ground-plate slots 114. However, in other examples, such as shown in FIGS. 2A-4B, the ground plate 112 of the device 100 includes two ground-plate segments 113 and one ground-plate slot 114. Each one of the ground-plate slots 114 forms part of a phase-shifting circuit 115 of the device 100. Accordingly, for a device 100 with multiple ground-plate slots 114, the device 100 also includes multiple phase-shifting circuits 115. In various examples, a width W2 of the ground-plate slot 114, in a direction parallel to the longitudinal direction 134, is constant along an entire length of the ground-plate slot 114, in a direction parallel to the lateral direction 133. However, in some examples, the width W2 of the ground-plate slot 114 varies along the length of the ground-plate slot 114.

The ground plate 112 is coupled with the first microstrip 102 and the second microstrip 108 such that at least one of the first microstrip 102 and the second microstrip 108 is movable relative to the ground plate 112 as the one or both of the first microstrip 102 and the second microstrip 108 move relative to each other. The ground plate 112 facilitates linear movement of the first microstrip 102 and the second microstrip 108. For example, the first microstrip 102 and the second microstrip 108 can be movable within the same plane or within planes that are parallel to each other. The ground plate 112 lies within a plane that is parallel to the plane or planes within which the first microstrip 102 and the second microstrip 108 move.

The ground plate 112 is positioned relative to the first microstrip 102 and the second microstrip 108 such that a gap 152 is defined between the ground plate 112 and the first-microstrip conductive layer 154A and defined between the ground plate 112 and the second-microstrip conductive layer 154B. The gap 152 helps electrically insulate the ground plate 112 from the first-microstrip conductive layer 154A and the second-microstrip conductive layer 154B. In this manner, there are no metal-to-metal connections between the first microstrip 102 and the second microstrip 108, which prevents passive intermodulation between the first microstrip 102 and the second microstrip 108 from occurring. In one example, the gap 152 is unfilled (e.g., filled only with air) such that the air within the gap 152 promotes the electrical insulation between the first-microstrip conductive layer 154A and the second-microstrip conductive layer 154B, and the ground plate 112. However, in other examples, to promote electrical insulation between the ground plate 112 and the first-microstrip conductive layer 154A and the second-microstrip conductive layer 154B, the gap 152 is filled with a dielectric film 153. In certain examples, the first microstrip 102 and the second microstrip 108 slide along the dielectric film 153 as they move relative to each other. The dielectric film 153 can be made of any of various dielectric materials other than air.

Although not shown, the first microstrip 102 and the second microstrip 108 can be supported relative to the ground plate 112 by any of various support structures, such as brackets, rails, bearings, and the like. Moreover, the ground plate 112 can be held stationary, relative to the first microstrip 102 and the second microstrip 108 via an any of various support structures, as the first microstrip 102 and the second microstrip 108 move relative to each other.

In some examples, the device 100 additionally includes at least one actuator 214 (e.g., a translational actuator) that is selectively operable to move the first microstrip 102 and/or the second microstrip 108. The actuator 214 can be any of various actuators (e.g., pneumatic, hydraulic, and/or electromagnetic cylinders, motors, etc.) configured to induce linear movement of the first microstrip 102 and/or the second microstrip 108. In some examples, the device 100 includes multiple actuators 214 each coupled to a corresponding one of the first microstrip 102 and/or the second microstrip 108 and each selectively operable to move the corresponding one of the first microstrip 102 and/or the second microstrip 108. In certain examples, the at least one actuator 214 synchronously moves both the first microstrip 102 and the second microstrip 108 relative to each other and the ground plate 112, such that the width W1 of the microstrip-to-slot transition region 110 can be synchronously adjustable.

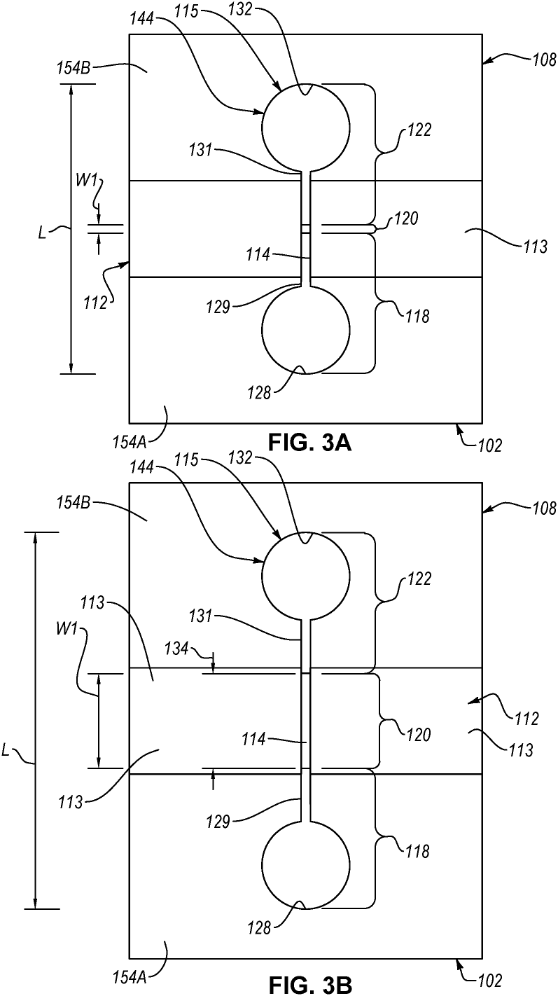

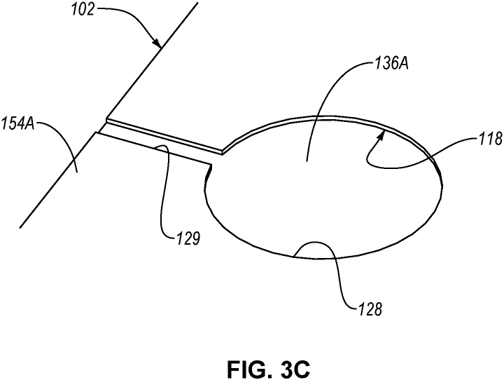

Referring to FIGS. 3A, 3B, 5, and 6, the device 100 also includes a transition slot 144 that forms part of each phase-shifting circuit 115. The transition slot 144 extends from the first microstrip 102 to the second microstrip 108 and facilitates an electrical connection, via inductive and capacitive properties, between the input terminal 104 and the output terminal 106. More specifically, the transition slot 144 defines an open space along which an induction wave (e.g., magnetic flux) travels to form an induction-based electrical connection between the input terminal 104 and the output terminal 106. The transition slot 144 includes a first-microstrip segment 118 formed in the first microstrip 102 and a second-microstrip segment 122 formed in the second microstrip 108. Additionally, the transition slot 144 includes a ground-plate segment 120 that couples together (e.g., is contiguous with) the first-microstrip segment 118 and the second-microstrip segment 122. The ground-plate segment 120 is defined by the ground-plate slot 114.

The first-microstrip segment 118 and the second-microstrip segment 122 are the corresponding spaces defined by cut-outs formed in the first-microstrip conductive layer 154A and the second-microstrip conductive layer 154B, respectively. A close-up view of the first-microstrip segment 118 is shown in FIG. 3C. The cut-out formed in the first-microstrip conductive layer 154A exposes the underlying first-microstrip dielectric layer 136A. Accordingly, the first-microstrip segment 118 of the transition slot 144 is defined between the sides of the cut-out in the first-microstrip conductive layer 154A and the exposed portion of the first-microstrip dielectric layer 136A. The second-microstrip segment 122 is similarly defined. Although termed a cut-out, it is recognized that the cut-out need not be formed by cutting out or removing an existing portion of a conductive layer, but can be formed as an absence of conductive material applied onto the dielectric layer.

Each one of the first-microstrip segment 118 and the second-microstrip segment 122 of the transition slot 144 includes a terminus and an intermediate portion. The terminus is wider than the intermediate portion. According to one example, the first-microstrip segment 118 includes a first transition-slot terminus 128 and a first transition-slot intermediate portion 129. Similarly, the second-microstrip segment 122 includes a second transition-slot terminus 132 and a second transition-slot intermediate portion 131. The ground-plate segment 120 extends between the first transition-slot intermediate portion 129 and the second transition-slot intermediate portion 131. The first transition-slot terminus 128 and second transition-slot terminus 132 are larger than the first transition-slot intermediate portion 129 and the second transition-slot intermediate portion 131, respectively, and larger than the ground-plate segment 120. Accordingly, as used herein, the transition slot 144 can be considered to have a dumbbell shape. As used herein, a dumbbell shape includes two relatively large shapes connected together by a relatively small shape. In some examples, the first transition-slot terminus 128 and the second transition-slot terminus 132 have the same shape, which can be a circular shape (see, e.g., FIG. 3A-5) or can be a non-circular shape (see, e.g., FIG. 6).

As the first microstrip 102 and the second microstrip 108 move relative to each other, a length L of the transition slot 144 changes (see, e.g., FIGS. 3A and 3B). More specifically, as shown in FIGS. 3A and 3B, as the first microstrip 102 and the second microstrip 108 move toward each other, and the width W1 of the microstrip-to-slot transition region 110 changes, the length of the ground-plate segment 120 of the transition slot 144 decreases, thus resulting in an overall decrease in the length of the transition slot 144. In contrast, as the first microstrip 102 and the second microstrip 108 move away from each other, the length of the ground-plate segment 120 of the transition slot 144 increases, thus resulting in an overall increase in the length of the transition slot 144. To be clear, although the length of the ground-plate slot 114 does not change, the portion of the ground-plate slot 114 defining the ground-plate segment 120 of the transition slot 144 does change as the first microstrip 102 and the second microstrip 108 move relative to each other. As described below, a phase shift 206 of the electrical output signal 208 relative to the electrical input signal 204 is dependent on the length of the transition slot 144. Accordingly, movement of the first microstrip 102 and the second microstrip 108 relative to each other results in a corresponding phase change 216 of the electrical output signal 208 relative to the electrical input signal 204.

When an electrical input signal, such as the electrical input signal 204 from the input source 202, is applied to the phase-shifting circuit 115 at the input trace 142A, electrical current flows through the input trace 142A to the input terminal 104. From the input terminal 104, buildup of electrical current at the input terminal 104 generates an induction wave that travels through the transition slot 144 of the phase-shifting circuit 115 to the output terminal 106. Reception of the induction wave at the output terminal 106 causes electrical current to flow through the output trace 142B and be received at the transmitter 210 as the electrical output signal 208. As shown in FIG. 1, due to the effect of the transition slot 144 on the electrical input signal 204, the phase of the electrical output signal 208 is different (e.g., is shifted) relative to the phase of the electrical input signal 204. The difference in phase between the electrical input signal 204 and the electrical output signal 208 is referred to as the phase shift 206 (see, e.g., FIGS. 9A-9C). Referring to FIG. 9A, one example of an electrical input signal 204 is shown. In FIG. 9B, one representative example of an electrical output signal 208, having a phase shift 206 relative to the electrical input signal 204 that is positive, is shown. In FIG. 9C, another representative example of an electrical output signal 208, having a phase shift 206 relative to the electrical input signal 204 that is positive, is shown.

As presented above, adjustments to the width W1 of the microstrip-to-slot transition region 110, and correspondingly the length of the transition slot 144, by moving the first microstrip 102 and the second microstrip 108 relative to each other proportionally changes the amount (e.g., degrees) of phase shift 206 between the electrical input signal 204 and the electrical output signal 208. Generally, the larger the width W1 and the longer the transition slot 144 (e.g., the further away the first microstrip 102 and the second microstrip 108 are from each other), the higher the phase shift 206. In contrast, the smaller the width W1 and the shorter the transition slot 144 (e.g., the closer the first microstrip 102 and the second microstrip 108 are to each other), the lower the phase shift 206. FIGS. 2A and 2B respectively show an example of the device 100 in a first configuration, with a relatively small width W1, and a second configuration, with a relatively large width W1. The width W1 of the microstrip-to-slot transition region 110 is adjustable between a minimum width and a maximum width, where the minimum width corresponds with a maximum phase shift of the device and the minimum width corresponds with a minimum phase shift of the device.

Similarly, FIGS. 3A and 3B respectively show an example of the device 100 in a first configuration, with a relatively small width W1, and a second configuration, with a relatively large width W1. Likewise, FIGS. 4A and 4B respectively show an example of the device 100 in a first configuration, with a relatively small width W1, and a second configuration, with a relatively large width W1. Accordingly, the device 100 provides for variable phase shifting of an electrical signal by passively filtering an electrical input signal 204, via manipulation of capacitive and inductive properties of a phase-shifting circuit 115, to shift the phase of an electrical output signal 208.

A controller of the system 200 can include a table that correlates various widths W1 of the microstrip-to-slot transition region 110 to corresponding degrees of phase shift 206. Based on a desired phase shift, the controller can reference the table and control the actuator 214 to move the first microstrip 102 and the second microstrip 108 relative to each other to achieve a width W1 of the microstrip-to-slot transition region 110 that corresponds with the desired phase shift. In some examples, the controller and the actuator 214 are configured to provide unlimited adjustability of the width W1 of the microstrip-to-slot transition region 110 and the phase shift 206. However, in other examples, the controller and the actuator 214 are configured to provide incremental adjustability (e.g., discrete, stepped adjustments) of the width W1 of the microstrip-to-slot transition region 110 and the phase shift 206.

According to some examples, the electrical input signal 204 has a frequency between about 600 MHz and 5.2 GHz, inclusive. For example, the electrical input signal 204 can have a frequency of one of about 600 MHz, 700 MHz, 1.9 GHz, 2.5 GHz, and 5.2 GHz. The electrical output signal 208 can have the same frequency as the electrical input signal 204, but have a different phase as described above.

In some examples, the first microstrip 102 and the second microstrip 108 are identically configured such that the first microstrip 102 and the second microstrip 108 are interchangeable. In this manner, although in the illustrated example the first microstrip 102 includes the input terminal 104 and the second microstrip 108 includes the output terminal 106, the input terminal 104 can be the output terminal 106, and vice versa, by switching the electrical input signal 204 from the first microstrip 102 to the second microstrip 108 and receiving the electrical output signal 208 at the first microstrip 102.

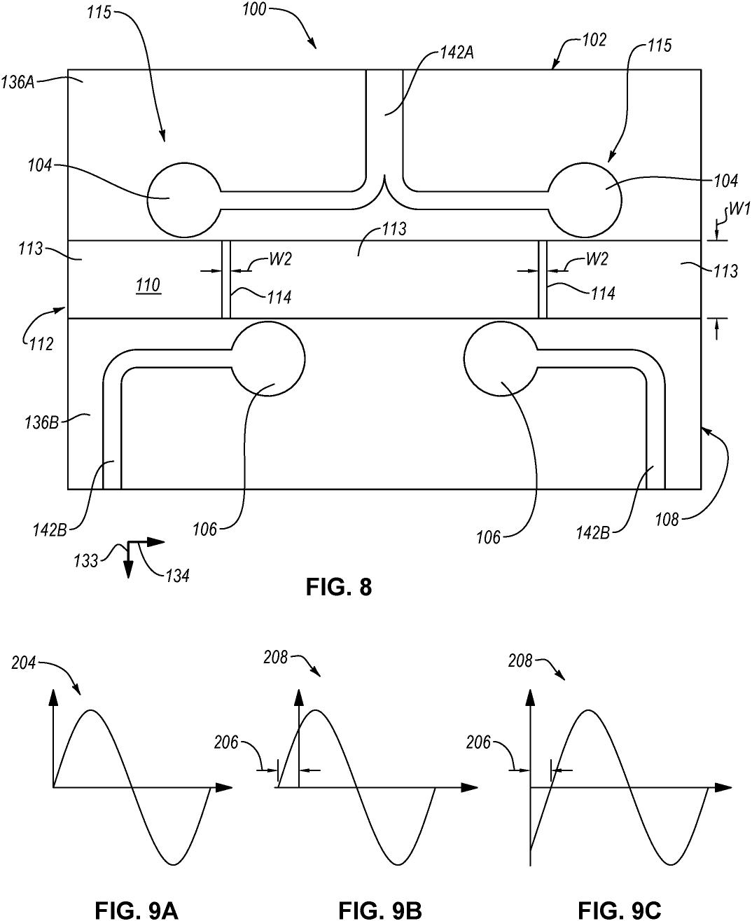

Additionally, although in some examples, the device 100 includes a single phase-shifting circuit 115 for generating a single electrical output signal 208 (see, e.g., FIG. 2A-6), in some examples, as shown in FIGS. 1 and 8, the device 100 can include a chain of phase-shifting circuits 115 for generating multiple electrical output signals. According to the example of the device 100 in FIG. 1, multiple phase-shifting circuits 115 are connected in series, which enables generation of multiple electrical output signals, having a phase shift 206 consistent among all the electrical output signals, from a single electrical input signal 204. Because the shift in phase is dependent on the width W1 of the microstrip-to-slot transition region 110, and the width W1 is the same along the entirety of the device 100 for all of the phase-shifting circuits 115, the phase shift of the multiple electrical output signals, relative to the corresponding electrical input signals, is the same.

According to one particular example, as shown in FIG. 1, a first one of multiple phase-shifting circuits 115 of the device 100 shifts the phase of the electrical output signal 208, relative to the electrical input signal 204, by the phase shift 206. The electrical output signal 208 then becomes an electrical input signal for a second one of the multiple phase-shifting circuits 115 of the device 100 (e.g., the next phase-shifting circuit 115 in series with the first one of the multiple phase-shifting circuits 115). The second one of the multiple phase-shifting circuits 115 shifts the phase of a second electrical output signal 208A, relative to the electrical output signal 208, by the same phase shift 206. The second electrical output signal 208A then becomes an electrical input signal for a third one of the multiple phase-shifting circuits 115 of the device 100. The third one of the multiple phase-shifting circuits 115 shifts the phase of a third electrical output signal 208B, relative to the second electrical output signal 208A, by the same phase shift 206. The third electrical output signal 208B then becomes an electrical input signal for a fourth one of the multiple phase-shifting circuits 115 of the device 100. The fourth one of the multiple phase-shifting circuits 115 shifts the phase of a fourth electrical output signal 208C, relative to the third electrical output signal 208B, by the same phase shift 206. The fourth electrical output signal 208C then becomes an electrical input signal for a fifth one of the multiple phase-shifting circuits 115 of the device 100. The fifth one of the multiple phase-shifting circuits 115 shifts the phase of a fifth electrical output signal 208D, relative to the fourth electrical output signal 208C, by the same phase shift 206.

In contrast to FIG. 1, another example of a device 100 having multiple phase-shifting circuits 115 is shown in FIG. 8. Similar to the device 100 of FIG. 1, the device 100 of FIG. 8 receives an electrical input signal and provides electrical output signals having phase shifts relative to the input signal. However, the device 100 of FIG. 8 provides two electrical output signals that have the same phase shift relative to a common input signal. Accordingly, the electrical output signals produced by the device 100 of FIG. 8 have the same phase, whereas the electrical output signals produced by the device of FIG. 1 have different phases.

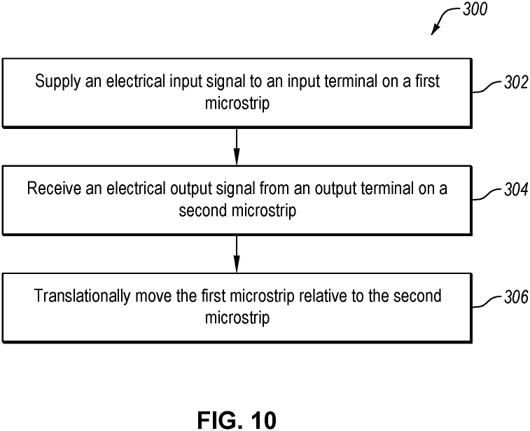

According to FIG. 10, one example of a method 300 of shifting the phase of an electrical signal, using the system 200 and the device 100, is shown. The method 300 includes (block 302) supplying the electrical input signal 204 to the input terminal 104 of the first microstrip 102 and (block 304) receiving the electrical output signal 208 from the output terminal 106 on the second microstrip 108. The phase of the electrical output signal 208 differs from the phase of the electrical input signal 204 by a first phase shift (e.g., a first change in degrees). The method 300 further includes (block 306) moving the first microstrip 102 relative to the second microstrip 108, while keeping fixed the phase of the electrical input signal 204, such that the phase of the electrical output signal 208 differs from the phase of the electrical input signal 204 by a second phase shift (e.g., a second change in degrees) that is different than the first phase shift.

In one example, the step of (block 306) moving the first microstrip 102 relative to the second microstrip 108 includes widening or narrowing the width W1 of the microstrip-to-slot transition region 110 defined between the first microstrip 102 and the second microstrip 108. The widening or narrowing of the width W1 may be either continuous or discrete. For example, a continuous widening connotes an infinite number of widths W1 between the first microstrip 102 and the second microstrip 108. A discrete widening connotes a fixed, finite, or set number of widths W1 between the first microstrip 102 and the second microstrip 108. In certain examples, the step of (block 306) moving the first microstrip 102 relative to the second microstrip 108 includes translationally moving the first microstrip 102 in a first linear direction, away from or towards the second microstrip 108, and translationally moving the second microstrip 108 in a second linear direction, away from or towards the first microstrip 102.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A device for shifting phase of an electrical signal, the device comprising:
a first microstrip, comprising an input terminal;
a second microstrip, comprising an output terminal, wherein the second microstrip is spaced apart from the first microstrip such that a microstrip-to-slot transition region is defined between the first microstrip and the second microstrip; and
a ground plate, comprising a ground-plate slot that spans the microstrip-to-slot transition region, wherein the ground plate is coupled with the first microstrip and the second microstrip such that at least one of the first microstrip and the second microstrip are movable relative to each other and to the ground plate to adjust a width of the microstrip-to-slot transition region.

2. The device of claim 1, further comprising a transition slot, extending from the first microstrip to the second microstrip, wherein the transition slot comprises:
a first-microstrip segment formed in the first microstrip;
a second-microstrip segment formed in the second microstrip; and
a ground-plate segment, contiguous with the first-microstrip segment and the second-microstrip segment, and comprising the ground-plate slot, wherein adjustment of the width of the microstrip-to-slot transition region corresponds with an adjustment to a length of the transition slot.

3. The device of claim 2, wherein the transition slot has a dumbbell shape.

4. The device of claim 1, wherein the input terminal is offset from the output terminal in a direction that is perpendicular to the width of the microstrip-to-slot transition region.

5. The device of claim 1, wherein:
the first microstrip further comprises a first-microstrip dielectric layer;
the second microstrip further comprises a second-microstrip dielectric layer;
the input terminal of the first microstrip is applied onto the first-microstrip dielectric layer, such that the first-microstrip dielectric layer is between the input terminal of the first microstrip and the ground plate; and
the output terminal of the second microstrip is applied onto the second-microstrip dielectric layer, such that the second-microstrip dielectric layer is between the output terminal of the second microstrip and the ground plate.

6. The device of claim 1, further comprising a gap defined between the ground plate and the first microstrip and between the ground plate and the second microstrip, wherein the gap is filled with a dielectric material consisting of at least one of air or a dielectric film.

7. The device of claim 1, wherein the ground-plate slot has a fixed slot width.

8. The device of claim 1, wherein:
the first microstrip further comprises an input trace electrically coupled with the input terminal;
the second microstrip further comprises an output trace electrically coupled with the output terminal; and
each one of the input terminal and the output terminal has a circular shape.

9. The device of claim 1, wherein:
the first microstrip further comprises an input trace electrically coupled with the input terminal;
the second microstrip further comprises an output trace electrically coupled with the output terminal; and
each one of the input terminal and the output terminal has a non-circular shape.

10. The device of claim 1, wherein the input terminal and the output terminal have the same shape.

11. The device of claim 1, wherein the width of the microstrip-to-slot transition region is adjustable between a minimum width and a maximum width, and wherein the minimum width corresponds with a maximum phase shift of the device and the minimum width corresponds with a minimum phase shift of the device.

12. The device of claim 1, wherein:
the first microstrip further comprises:
a first-microstrip dielectric layer interposed between the ground plate and the input terminal; and
a first-microstrip conductive layer, the first-microstrip dielectric layer interposed between the first-microstrip conductive layer and the input terminal; and
the second microstrip further comprises:
a second-microstrip dielectric layer interposed between the ground plate and the output terminal; and
a second-microstrip conductive layer, the second-microstrip dielectric layer interposed between the second-microstrip conductive layer and the output terminal.

13. The device of claim 12, wherein:
the ground plate is made from aluminum; and
the first-microstrip conductive layer and the second-microstrip conductive layer are made from copper.

14. A system, comprising:
an input source that generates an electrical input signal;
a first microstrip, comprising an input terminal;
a second microstrip, comprising an output terminal, wherein the second microstrip is spaced apart from the first microstrip such that a microstrip-to-slot transition region is defined between the first microstrip and the second microstrip;
a ground plate, comprising a ground-plate slot that spans the microstrip-to-slot transition region, wherein the ground plate is coupled with the first microstrip and the second microstrip such that at least one of the first microstrip and the second microstrip are translationally movable relative to each other and to the ground plate to adjust a width of the microstrip-to-slot transition region such that a phase shift of an electrical output signal is different than the electrical input signal;
a transmitter that receives the electrical output signal and transmits an electromagnetic radiation wave corresponding with the electrical output signal; and
a receiver that receives the electromagnetic radiation wave.

15. The system of claim 14, wherein the electrical input signal has a frequency in the group consisting of about 600 MHz, 700 MHz, 1.9 GHz, 2.5 GHz, and 5.2 GHz and the phase shift of the electrical output signal results in the electrical output signal that has a frequency in the group consisting of about 600 MHz, 700 MHz, 1.9 GHz, 2.5 GHz, and 5.2 GHz.

16. The system of claim 14, further comprising a translational actuator that is actuatable to translationally move at least one of the first microstrip and the second microstrip over the ground plate.

17. The system of claim 14, wherein the width of the microstrip-to-slot transition is continuously and synchronously adjustable.

18. A method of shifting phase of an electrical signal, the method comprising steps of:
supplying an electrical input signal to an input terminal on a first microstrip;
receiving an electrical output signal from an output terminal on second microstrip, wherein a phase of the electrical output signal differs from a phase of the electrical input signal by a first phase shift; and
moving the first microstrip relative to the second microstrip, while keeping fixed the phase of the electrical input signal, such that the phase of the electrical output signal differs from the phase of the electrical input signal by a second phase shift that is different than the first phase shift.

19. The method of claim 18, wherein the step of moving the first microstrip relative to the second microstrip further comprises widening or narrowing a width of a microstrip-to-slot transition region defined between the first microstrip and the second microstrip.

20. The method of claim 18, wherein moving the first microstrip relative to the second microstrip comprises translationally moving the first microstrip in a first linear direction, away from or towards the second microstrip, and translationally moving the second microstrip in a second linear direction, away from or towards the first microstrip.
